(19) United States
(12) Patent Application Publication
(10) Pub. No.: US 2005/0096108 A1
(43) Pub. Date: May 5, 2005

(54) Axial flow combine harvester with adaptable threshing unit

(76) Inventors: Eric P.J. Van Quekelberghe, Moerkerke (BE); Eric Cromheecke, Bredene (BE)

Correspondence Address: CNH AMERICA LLC, INTELLECTUAL PROPERTY LAW DEPARTMENT, 700 STATE STREET, RACINE, WI, 53404, US

(21) Appl. No.: 10/863,691

(22) Filed: Jun. 8, 2004

(30) Foreign Application Priority Data
Nov. 5, 2003 (GB) GB 0325904.1

(51) Int. Cl. A01F 7/06

(52) U.S. Cl. 460/66

(57) ABSTRACT

An axial flow combine harvester is described which comprises a rotor having a thresher section and a separator section. The thresher section includes pairs of rasp bars, which are staggered from one another along a helical path. Individual rasp bars of the pairs of rasp bars are located adjacent to the separator section of the rotor. The individual rasp bars are removable to render the action of the thresher section less aggressive. To reduce the risk of plugging when a trailing rasp bar is removed, a flow deflector plate is mountable in place of the removable rasp bars so as to guide the crop flow continuously from the remaining rasp bar to the infeed end of the separator section of the rotor.

### CROSS REFERENCE TO RELATED APPLICATIONS

This Patent Application claims priority under 35 U.S.C. § 119 to GB 0325904.1, filed on Nov. 5, 2003 entitled, “Axial Flow Combine Harvester with Adaptable Threshing Unit” and having Eric P. J. Van Quekelberghe and Eric Cromheecke as the Inventors. The full disclosure of GB 0325904.1 is hereby fully incorporated by reference.

### FIELD OF THE INVENTION

The present invention relates to agricultural harvesters and, more particularly, to axial flow combine harvesters having a threshing and separating unit with at least one generally longitudinally arranged rotor for advancing crop material along a generally helical path.

### BACKGROUND AND SUMMARY OF THE INVENTION

In conventional combine harvesters crop material is fed between a threshing cylinder and an associated threshing concave, which extend transversely to the direction of combine travel. Here, the crop is threshed over a comparatively short distance. Axial flow machines, on the other hand, use one or more longitudinally arranged rotors and associated concaves.

Generally, each rotor includes a threshing section, which immediately follows an infeed section, the infeed section generally delivering the crop material to the rotor. A separating section follows the threshing section. The threshing section has a plurality of sets of rasp bars, such as a leading rasp bar and a trailing rasp bar, which are provided at predetermined positions around the periphery of the threshing section of the rotor. The crop material is threshed along the longitudinal extent defined by the rotor, which results in increased harvesting efficiency because a higher degree of separation is reached and grain losses are reduced.

Accordingly, axial flow combines are popular in regions with a continental climate, where the crops to be harvested ripen well and contain hardly any green parts at the time of the harvest. However, when the crop contains green material, such axial flow units can be particularly prone to plugging by slugs of accumulated crop material that lodge between the leading and trailing rasp bars of the rotor and the concaves.

For this reason, it is advantageous that selected ones or all of the trailing rasp bars be removably mounted on the rotor to allow the rotor to be adapted to suit the crop being harvested. However, removal of every trailing rasp bar from the rotor, especially from near the end of the thresher section adjacent the separator section, can result in an uneven crop flow from the thresher section into the separator section of the rotor. This uneven crop flow can also cause plugging.

With a view toward mitigating the foregoing disadvantage, the present invention provides an axial flow combine harvester comprising a rotor having a thresher section and a separator section. The thresher section includes pairs of rasp bars, such as a leading rasp bar and a trailing rasp bar. The pairs of rasp bars are preferably staggered from one another along a helical path of the rotor. Individual trailing rasp bars of at least each of the pairs of rasp bars are removable to render the action of the thresher section less aggressive. More specifically, a flow deflector plate can be mounted in the position of the removed trailing rasp bar to guide the crop flow continuously from the remaining, leading rasp bar into the separator section of the rotor.

Preferably, the flow deflector plate includes a first section that extends generally tangentially with respect to the rotor in line with serrations of the remaining, leading rasp bar. The flow detector plate also preferably includes a second section for deflecting the crop to follow a helical path into the separator section of the rotor.

The height of the first section of the deflector plate may be ramped upward from the height of the remaining, leading rasp bar on the threshing section and increase at the second section to the same radial height as defined by the crop engaging blades of the separator section.

Accordingly, the present invention discloses an axial flow combine harvester with adaptable threshing unit, which may be used in continental climates where crops to be ripen well or which may be adapted for use with crops that contain green parts at the time of harvest and which are susceptible to plugging of the rotor under normal circumstances.

### BRIEF DESCRIPTION OF THE DRAWINGS

The advantages of this invention will become apparent upon consideration of the following detailed disclosure of the invention, especially when taken in conjunction with the accompanying drawings, wherein:

FIG. 1 is a diagrammatic, partly sectional side view of a known combine harvester described in the Applicants' earlier U.S. Pat. No. 6,494,782 B1 having an axial flow threshing and separating unit;

FIG. 2 is an enlarged side view of one of the rotors of the threshing and separating unit of FIG. 1;

FIG. 3 is cross sectional view of the rotor, taken along line III--III of FIG. 2;

FIG. 4 is an alternative design of rotor in which the layout of the supports of the crop engaging elements in the separator section has been modified from that shown in FIG. 2, to permit attachment of a continuous separator blade;

FIG. 5 is the rotor of FIG. 4 when fitted with a continuous separator blade;

FIG. 6 shows the rotor of FIG. 5 in which some of the rasp bars have been removed from the thresher section of the rotor to render the threshing section less aggressive; and

FIG. 7 shows a detail of the rotor of FIG. 6 drawn to enlarged scale illustrating a crop flow deflector position in lieu of one of the removed rasp bars so as to improve crop flow and reduce the risk of the crop being wound around the rotor and creating a blockage.

### DETAILED DESCRIPTION OF THE PREFERRED EMBODIMENTS

The terms “grain”, “straw” and “tailings” are used principally throughout this specification for convenience and it is to be understood that these terms are not intended to be limiting. Thus “grain” refers to that part of the crop material which is threshed and separated from the discardable part of the crop material, which is referred to as “straw”. Incompletely threshed crop material is referred to as “tailings”. Also the terms “forward”, “rearward”, “left” and “right”, when used in connection with the combine harvester and/or components thereof, are determined with reference to the direction of forward operative travel of the combine harvester, but again, they should not be construed as limiting. The terms “longitudinal” and “transverse” are determined with reference to the fore-and-aft direction of the harvester and are equally not to be construed as limiting.

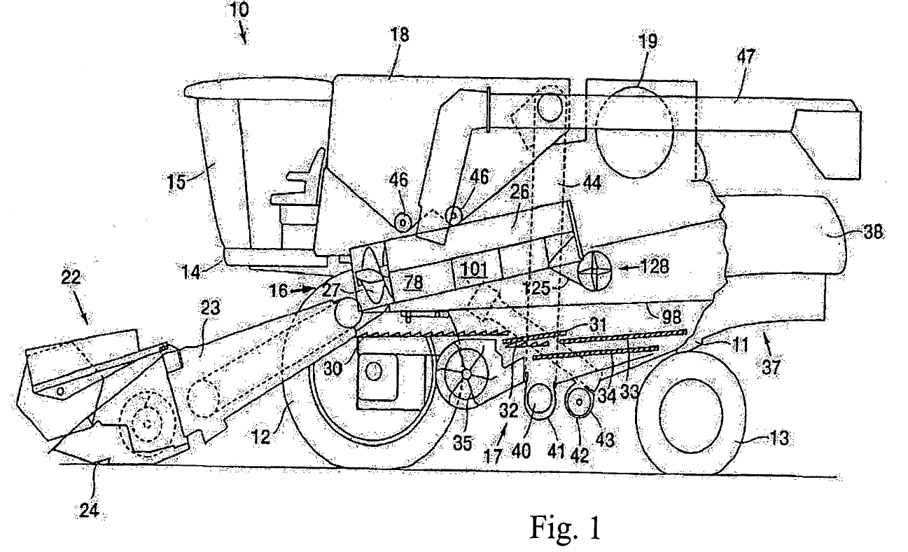

The combine harvester 10 shown in FIG. 1 of the accompanying drawings is of the axial-flow type, wherein crop material is threshed and separated while it is advanced by and along a longitudinally arranged rotor. The combine harvester 10 comprises a chassis or main frame 11 having a pair of driven, ground-engaging front wheels 12 and a pair of smaller, steerable rear wheels 13. Supported on the main frame 11 are an operator's platform 14 with an operator's cab 15, a threshing and separating assembly 16, a grain cleaning assembly 17, a grain tank 18 and a power plant or engine 19. A conventional header 22 and straw elevator 23 extend forwardly of the main chassis 11 and are pivotally secured thereto for generally vertical movement, which are controlled by appropriate actuators as are known in the art, such as hydraulic cylinders (not shown).

As the combine harvester 10 is propelled forwardly over a field with standing crop, the latter is severed from the stubble by a sickle bar 24 at the front of the header 22. Thereafter, the header and the straw elevator 23 supply the cut crop to the threshing and separating assembly 16.

The threshing and separating assembly 16 comprises at least one generally cylindrical chamber 26 in which at least one rotor 27 is rotated to thresh and separate the crop received therein, that is to say, the crop is rubbed and beaten between the rotor 27 and the inner surfaces of the chamber 26, whereby the grain, seed or the like, is loosened and separated from the straw. The chamber 26 and the rotor 27 are described in further detail hereinafter.

Grain, which has been separated by the threshing and separating assembly 16, falls onto a first grain pan 30 of the cleaning assembly 17, which further also comprises a pre-cleaning sieve 31. The pre-cleaning sieve 31 is positioned above a second grain pan 32, a pair of sieves 33 and 34, one of which is disposed above the other, and a cleaning fan 35.

The grain pans 30 and 32 and the sieves 31, 33, and 34 are oscillated generally back-and-forth for transporting threshed and separated grain from the first grain pan 30 to the pre-cleaning sieve 31 and the second grain pan 32 and therefrom to the sieves 33 and 34. The same oscillatory movement spreads the grain across the sieves 31, 33, and 34 while permitting the passage of cleaned grain by gravity through the apertures of these sieves. The grain on the sieves 31, 33, and 34 is subjected to a cleaning action by the fan 35, which provides an air flow through the sieves to remove chaff and other impurities, such as dust from the grain, by making this material airborne for discharge from the machine through an outlet 37 of the straw hood 38.

Clean grain falls to a clean grain auger 40 in a clean grain auger trough 41 and is subsequently transferred therefrom by a grain elevator 44 to the grain tank 18. Tailings fall to a tailings auger (not shown) in a tailings auger trough 42. The tailings are transported sideways by the tailings auger to a separate rethresher 43 and returned by a tailings conveyor to the cleaning assembly 17 for repeated cleaning action.

A pair of grain tank augers 46 at the bottom of the grain tank 18 are used to urge the clean grain .sideways to an unloading tube 47 for discharge from the combine harvester 10.

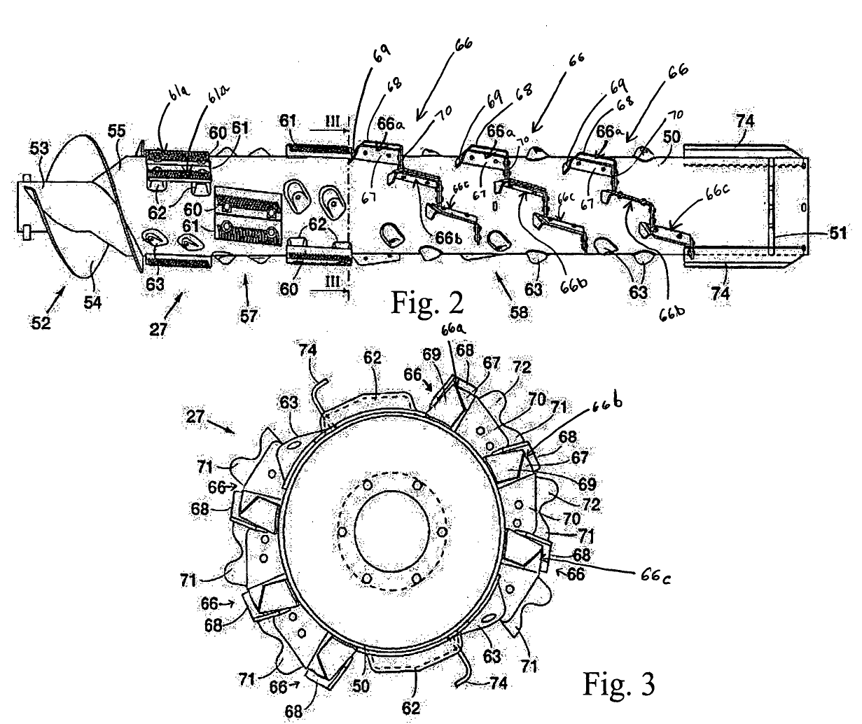

The rotors 27 of the threshing and separating assembly 16 are mirror images of each other. The left-hand rotor 27, which is shown in FIGS. 2 and 3, is rotated by appropriate means (not shown) in a counter-clockwise direction as seen from the front of the combine harvester 10. The right-hand rotor (not shown) is rotated in the opposite sense. A cylindrical tube mounted on discs 51, which are supported on front and rear stub shafts (not shown), constitutes the main body 50 of each rotor 27.

The front end of the rotor 27 is provided with an infeed section 52 having a cylindrical tube portion 53 of reduced diameter and a conical tube portion 55, which provides a transition between the tube portion 53 and the main body 50 of the rotor 27. A pair of auger flights 54 are welded to the infeed section of each rotor 27 and serve to transfer crop material from the rear end of the straw elevator 23 to the left and right threshing and separating chambers 26 (see FIG. 1).

Turning back to FIGS. 2 and 3, it can be seen that each rotor 27 has a threshing section 57 immediately following the infeed section 52. A separating section 58 follows the threshing section 57. The threshing section 57 has a plurality of rasp bars, such as a leading rasp bar 60 and a trailing rasp bar 61. The leading rasp bar 60 and trailing rasp bar 61 are bolted onto rasp bar mounts 62, which are provided at predetermined positions around the periphery of the threshing section 57. Each of the leading rasp bar 60 and the trailing rasp bar 61 includes a plurality of serrations, such as serrations 61a. The rasp bar mounts 62 are arranged in pairs for securely fastening the leading rasp bar 60 and the trailing rasp bar 61 thereto. Also, additional mounts 63 are provided at predetermined positions both in the threshing section 57 and the separating section 58. These additional mounts 63 can be used for mounting thinning rods (not shown) to the rotor 27.

Further details on the configuration of the mounts 62 and 63 and the leading and trailing rasp bars 60 and 61 can be taken from U.S. Pat. No. 4,889,517, column 3, line 31 to column 7, line 15, assigned to Ford New Holland, Inc., a common assignee with the present application, and which is incorporated herein by reference.

Turning now to the separating section 58 of the rotor 27, it can be seen that the separating section 58 has several sets of supports 66 for crop engaging elements. Each set of supports 66 is preferably identical to one another and comprises three individual supports, such as an individual support 66a, an individual support 66b, and an individual support 66c. Each set of supports 66 is arranged along helical paths on the rotor body 50. More specifically, the individual supports 66a, 66b, and 66c are welded at predetermined positions to the separating section 58 so that each of the individual supports 66a, 66b, and 66c are staggered with respect to one another. Each of the individual supports 66a, 66b, and 66c is preferably made out of sheet material and generally takes the shape of an inverted “U” with the legs extending rearwardly with respect to the normal crop flow.

Because each of the individual supports 66a, 66b, and 66c is preferably identical to one another, only the individual support 66a will be discussed herein in detail. However, it should be understood that because each of the individual supports 66a, 66b, and 66c are preferably identical to one another, they can be identically numbered and identified within the drawings as follows.

Referring to FIGS. 2 and 3, it can be seen that the individual support 66a includes a front section 69, which is almost perpendicular to the cylindrical surface of the rotor 27. The surface of the front section 69 is preferably inclined slightly rearwardly so that its outer edge slopes inwardly towards the surface of the rotor.

The individual support 66a further includes a middle section 67. The middle section 67 of individual support 66a is oriented in a generally longitudinal direction. It is positioned at an acute angle (in the range of 12°) to the axis of rotor 27 for better matching the helical flow of the straw and other crop material along the confines of the chamber 26. The surface of the middle section 67 extends from the rotor surface; its leading face is inclined rearwardly with respect to the direction of rotation of the rotor 27. The face may be positioned at an angle of about 75° to the surface of the tube 50. The middle section 67 includes a pair of mounting holes for attaching to its leading face a generally rectangular crop engaging element, such as a wear plate 68.

The wear plate 68 includes a front edge which is inclined outwardly and rearwardly to match the plane of the adjacent front section 69. The wear plate 68 further includes an outer edge, which extends beyond the outer edge of the individual support 66a. Because of its backwards inclined orientation (about 15°), the leading face of the wear plate 68 tends to force the crop material outwardly against the confines of the cylindrical chamber 26.

Individual support 66a further includes a rear section 70, which extends from the rear end of the middle section 67 in a direction which is generally transverse to the axis of the rotor 27, at an angle of about 87° thereto. The plane of the rear section 70 is generally perpendicular to the surface of tube 50. As shown in FIG. 3, the rear section 70 is also provided with a pair of mounting holes for attaching thereto another crop engaging element, such as a wear finger plate 71. The wear finger plate 71 also has a leading edge, which is inclined backwards, thereby matching the plane of the longitudinal wear plate 68.

At its leading end, the wear finger plate 71 includes a curved protrusion 72, which extends beyond the individual support 66a and constitutes the most outward part of the separating section 58 of the rotor 27. The middle portion of the wear finger plate 71 is curved inwardly and its trailing portion has a substantially straight edge, parallel to the rotor tube 50 and ending short of the front face of the next longitudinal wear plate 68 (i.e. the wear plate 68 associated with individual support 66b). The curved protrusion 72 of the wear finger plate 71 engages the crop flow inside the chamber 26 and has a thinning and splitting effect thereupon. Consequently the chances for “roping” of the straw and consequential blocking of the rotors 27 are reduced substantially by the dedicated outer profile of the wear finger plate 71. This is especially effective under circumstances where the stems of the crop material still contain some moisture or humidity.

The thinning effect of the rotor 27 can be further enhanced by mounting thinning rods (not shown) to the mounts 63, which are distributed between the sets of supports 66. These rods extend perpendicularly from the flat surfaces of mounts 63, which are inclined in two planes so as to impart a trailing angle and a rearward angle for each thinning rod. The trailing angle is defined with respect to the radius of the rotor 27 passing through the bottom end of the rod on the one hand and may be about 30°. The rearward angle is defined as the angle between the rod and the diametral plane of the rotor passing through the same bottom end and may be 32°. The overall orientation of the rods forces the crop material outwardly while their tips smooth the layer along the inner surface of the chamber 26.

The rotor 27 further includes a pair of longitudinally arranged paddles 74, which are located near the rear end of the rotor 27. These paddles 74 extend perpendicularly from the rotor tube 50 and assist in discharging the straw from the threshing and separating assembly 16.

While the helically staggered crop engaging elements of the separator section of the rotor shown in FIGS. 2 and 3 have been successfully used in combines for harvesting many different types of grain, it has been found to work less efficiently when harvesting grains such as corn and sunflowers because the rotor's 27 separating action is too aggressive. Thus, to optimize operation under all conditions, it has hitherto been necessary to change rotors 27, which is costly and time consuming.

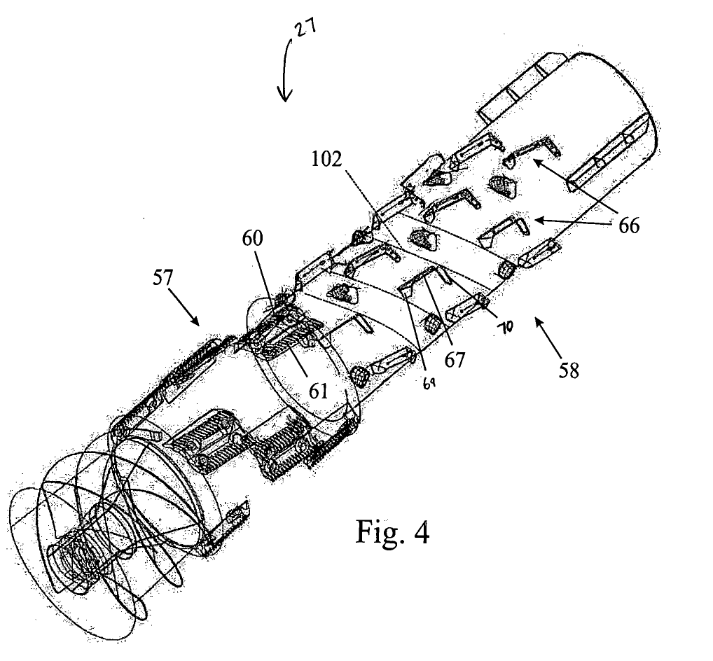

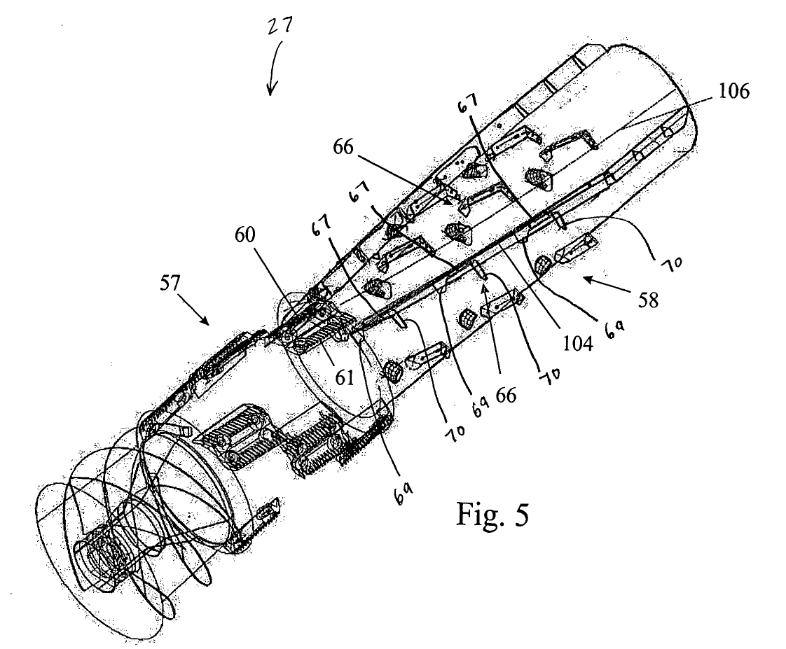

But, as shown by FIGS. 4 and 5, instead of changing rotors 27, the present invention allows for adaptation of the rotor 27 to suit any type of crop being harvested, including corn and sunflowers. The modification to the rotor 27 can be made without having to remove it from the combine harvester 10, it being only necessary to access the separator section 58 of the rotor 27 by removal of the surrounding concave assembly.

More specifically, in FIG. 4, there is shown a rotor 27 similar in operation to the rotor of FIG. 2 but in which the layout of the sets of supports 66 for the crop engaging elements has been modified to enable implementation of the present invention. As in the rotor 27 of FIG. 3, the supports 66 for the crop engaging elements are staggered about a helical crop flow path of relatively small pitch as represented by dotted lines 102. The small pitch of the helical path means that the crop makes several turns around the rotor 27, which makes the separating action too aggressive for such crops as corn and sunflowers.

The spacing of the supports 66 along the helical path 102 in FIG. 4 is significantly greater than the spacing of the supports 66 in the rotor 27 of FIG. 2. Turning now to FIG. 5, when a separator blade 104 is attached to selected supports 66, a helical crop flow path of greater pitch, represented by dotted line 106, is defined which achieves less aggressive separation and reduces the risk of plugging.

The rotor 27 of FIGS. 4 and 5, is intended to function in the same way as the rotor 27 of FIG. 2 when the separator blade 104 is not present. For this reason, it is desirable for the staggered crop engaging elements to have the same front sections 69 and rear sections 70 as earlier described in reference to FIGS. 2 and 3, so as to direct the crop along the first helical crop flow path 102. However the front sections 69 and rear sections 70 must be spaced from one another to allow the crop to flow along the second path 106 when the separator blade 104 is in place.

The separator blade 104 is preferably a single blade extending over the separator section 58 of the rotor 27 mounted in place of the wear plates 68 (see FIGS. 2 and 3). To enable this, it is preferable for the middle sections 67 of the supports 66 to be aligned along the second helical flow path 106. Alternatively, wedge-like brackets (not shown) can be used to secure the separator blade 104 to the selected brackets 66.

Instead of removing the wear plates 68 (see FIGS. 2 and 3) and fitting a single continuous blade 104, the wear plates 68 may be left on the supports 66 and form a separator blade 104 consisting of several segments. These segments may mate with one another to form a single continuous surface defining the second crop flow path 106.

In the same way as it is necessary to adapt the separator section 58 of the rotor to suit different crops, it is also desirable to modify the thresher section 57. The leading and trailing rasp bars 60 and 61 of the rotor 27 shown in FIG. 2 are arranged in pairs and it is possible to render the threshing section less aggressive by removing the second or trailing rasp bar 61 from all or selected pairs. It has been found, however, that removal of the second rasp bar 61 can result in an uneven crop flow into the separator section 58, causing the rotor 27 to plug up, especially when using the continuous spiral blade 104 in the separator section 58.

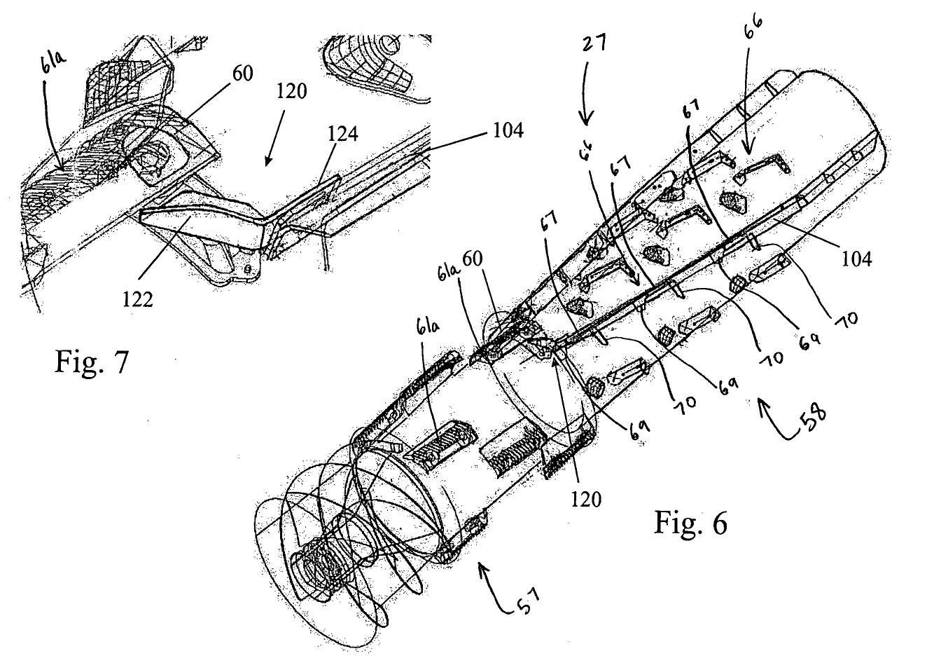

Accordingly, as is shown in FIGS. 6 and 7, this problem can be overcome in accordance with the present invention by placing a flow deflector plate 120 in the position of the removed trailing rasp bar 61. Such a flow deflector plate 120 has been found to reduce the risk of plugging and to reduce rumbling noise from the rotor 27. It has also been found to lower the power consumption of the rotor 27, increase throughput capacity and reduce MOG separation.

The deflector plate 120 is shaped to guide the crop flow continuously from the remaining, or leading rasp bar 60 to the infeed end of the separator section 58. In particular, the flow deflector plate 120 has a first section 122 extending generally tangentially with respect to the rotor 27 in line with the serrations 61a of the leading rasp bar 60 and a second section 124 for,deflecting the crop to follow a continuous helical path towards the infeed end of the separator section 58. The height of the second section 124 should be the same as that of the separator blade 104 while the height of the first section 122 is ramped to rise from the height of the leading rasp bar 60 to reach the height of the separator blade 104 midway along its length.

1. An axial flow combine harvester comprising:
a rotor having a thresher section and a separator section, the separator section having an infeed end, the thresher section including pairs of rasp bars staggered from one another along a helical path, the pairs of rasp bars including a leading rasp bar and a trailing rasp bar, wherein individual trailing rasp bars of the pairs of rasp bars are located adjacent the separator section of the rotor and are removable to render the action of the thresher section less aggressive, a flow deflector plate mountable in the location of a removed, trailing rasp bar to guide crop flow continuously from the remaining, leading rasp bar to the infeed end of the separator section.

2. The axial flow combine harvester of claim 1, wherein tie pairs of rasp bars include serrations, and wherein the flow deflector plate includes a first section and a second section, the first section extending generally tangentially with respect to the rotor in line with the serrations of the remaining rasp bar, tie second section deflecting the crop flow to follow a helical path toward the infeed end of the separator section.

3. The axial flow combine harvester of claim 2, wherein the separator section further includes crop engaging blades, the second section of the deflector plate defining a height identical to that of the crop engaging blades, and wherein the first section of the flow deflector plate defines a ramped height from a height defined by the remaining rasp bar to the height defined by the second section.

4. The axial flow combine harvester of claim 2, wherein the separator section comprises a continuous helical separator blade, and wherein the second section of the deflector plate lies closely adjacent the separator blade at the infeed end of the separator section of the rotor.

5. An axial flow combine harvester comprising:
a rotor having a thresher section and a separator section, the separator section having an infeed end, the thresher section including pairs of rasp bars staggered from one another along a helical path, wherein individual rasp bars of the pairs of rasp bars are located adjacent the separator section of the rotor and are removable to render the action of the thresher section less aggressive, a flow deflector plate mountable in the location of a removed rasp bar and located such that crop flow is encountered subsequent threshing, the flow deflector plate configured to guide threshed crop flow continuously from the remaining rasp bar to the infeed end of the separator section.

6. The axial flow combine harvester of claim 5, wherein the pairs of rasp bars include serrations, and wherein the flow deflector plate includes a first section and a second section, the first section extending generally tangentially with respect to the rotor in line with the serrations of the remaining rasp bar, the second section deflecting the crop flow to follow a helical path toward the infeed end of the separator section.

7. The axial flow combine harvester of claim 6, wherein the separator section further includes crop engaging blades, the second section of the deflector plate defining a height identical to that of the crop engaging blades, and wherein the first section of the flow deflector plate defines a ramped height from a height defined by the remaining rasp bar to the height defined by the second section.

8. The axial flow combine harvester of claim 6, wherein the separator section comprises a continuous helical separator blade, and wherein the second section of the deflector plate lies closely adjacent the separator blade at the infeed end of the separator, section of the rotor.

9. An axial flow combine harvester comprising:
a rotor having a thresher section and a separator section, the separator section having an infeed end, the thresher section including pairs of rasp bars staggered from one another along a helical path, wherein individual rasp bars of the pairs of rasp bars are located adjacent the separator section of the rotor and are removable to render the action of the thresher section less aggressive, a flow deflector plate mountable in the location of a removed rasp bar such that the flow deflector plate is located intermediate the thresher section and the separator section, the flow deflector plate configured to transition threshed crop flow continuously from the remaining rasp bar to the infeed end of the separator section.

10. The axial flow combine harvester of claim 9, wherein the pairs of rasp bars include serrations, and wherein the flow deflector plate includes a first section and a second section, the first section extending generally tangentially with respect to the rotor in line with the serrations of the remaining rasp bar, the second section deflecting the crop flow to follow a helical path toward the infeed end of the separator section.

11. The axial flow combine harvester of claim 10, wherein the separator section further includes crop engaging blades, the second section of the deflector plate defining a height identical to that of the crop engaging blades, and wherein the first section of the flow deflector plate defines a ramped height from a height defined by the remaining rasp bar to the height defined by the second section.

12. The axial flow combine harvester of claim 10, wherein the separator section comprises a continuous helical separator blade, and wherein the second section of the deflector plate lies closely adjacent the separator blade at the infeed end of the separator section of the rotor.
